(19) United States
(12) Patent Application Publication
(10) Pub. No.: US 2026/0133089 A1
(43) Pub. Date: May 14, 2026

(54) Reducing Sensitivity of a Force/Torque Sensor to Variations in Boundary Conditions

(71) Applicant: ATI Industrial Automation, Inc., Apex, NC (US)

(72) Inventors: Joseph Lipsey, Lillington, NC (US); Andrew Glusiec, Stroudsburg, PA (US)

(21) Appl. No.: 19/384,224

(22) Filed: Nov. 10, 2025

Related U.S. Application Data
(60) Provisional application No. 63/718,934, filed on Nov. 11, 2024.

(51) Int. Cl. G01L 25/00; G01L 5/00; G01L 5/16

(52) U.S. Cl. CPC G01L 25/003; G01L 5/0061; G01L 5/16

(57) ABSTRACT

Both mathematical and mechanical methods improve observed accuracies when F/T sensors deployed are mounted to tools in the field. Due to differences in boundary conditions between manufacturer tooling and the field tooling when deployed, differences may arise in calibration matrices calculated at time of manufacture and those required for use in the field. Mathematical methods of correcting or creating new calibration matrices are disclosed. Additionally, one or two boundary condition normalizing plates present uniform forces and torques to deformable members, regardless of boundary conditions.

### RELATED APPLICATIONS

This application claims the benefit of U.S. Provisional Application No. 63/718,934 filed 11 Nov. 2024, the entire disclosure of which being hereby incorporated by reference herein.

### FIELD OF INVENTION

The present invention relates generally to force and torque sensors, and in particular to a mathematical and mechanical approaches to reducing the sensitivity of force/torque sensors to changes in boundary conditions.

### BACKGROUND

Robots are an indispensable part of manufacturing, testing, assembly, and packing of products; assistive and remote surgery; space exploration; operation in hazardous environments; and many other applications. Many robots and robotic applications require quantization of forces applied or experienced, such as material removal (grinding, sanding, and the like), parts assembly, remote digging or other manipulation of the environment, and the like.

An industrial robot typically comprises a general-purpose actuator, or “arm,” which comprises numerous segments connected by electromechanical joints that move and rotate in different axes and planes, providing numerous degrees of freedom. A six degrees of freedom (6-DOF) robot arm is commonly used in industrial manufacturing, including operations such as welding, material handling, material removal, painting, and the like. The 6-DOF design provides motion in the x-, y-, and z-planes, and the flexibility, strength, and reach for many tasks. It can perform roll, pitch, and yaw movement of a robotic tool, or “end effector,” which interacts with a workpiece.

In many applications, it is necessary or desirable to monitor the forces between an end effector and a workpiece. For example, in “force control” tasks, the end effector is controlled to apply a predetermined force (or force within a predetermined range), requiring the contact force and/or torque to be measured and fed back to the robot control system. There are two conventional approaches to measuring forces and torques at the end of a 6-DOF robot: measuring torques at each of numerous joints of the robot, and calculating the resulting forces and torques at the end; and placing a 6-axis force/torque (F/T) sensor between the robot and end effector.

Robot joint torques can be estimated from motor currents. However, these results tend to be noisy. Alternatively, a joint torque sensor can be installed in each of several joints. Joint torque sensors tend to have higher accuracy and higher signal to noise ratio. Conventional joint torque sensors may follow the 6-axis force/torque sensor design described above, with adjustments to the sensor geometry and/or strain gage placement based on the requirement that only one torque (Tz) must be measured.

Known joint torque sensors have numerous deficiencies. They are usually sensitive to off-axis loads. That is, forces and torques other than the desired Tz will cause beam deformation and generate strain gage output, which may manifest as errors in the axial torque Tz measurement. Known joint torque sensor designs are also sensitive to torque ripple, which is often found when measuring torques close to strain wave gearboxes, also known as harmonic drives. The torque ripple is a periodic fluctuation in the torque measurement, which is difficult to compensate. Even after modifying the 6-axis force/torque sensor design to measure only axial torque Tz, the sensors, with precisely machined thin features (e.g., flexures) and numerous strain gages, are still expensive to manufacture. Because several of them are needed to instrument a 6-DOF robot arm, this approach remains cost-prohibitive in many applications.

U.S. Pat. No. 10,422,707, assigned to the assignee of the present application and incorporated herein by reference in its entirety, describes a compact 6-axis F/T sensor. The sensor is based on a conventional design comprising a hub (connected to the tool) connected to an annular ring (connected to the robot) by a plurality of deformable beams, which include flexures to increase the beams'deformation under load. Strain gages affixed to the deformable beams measure tension and compression in the beams'surfaces as they deform under applied loads, and strain gage circuit outputs are decoded and mapped to six forces (Fx, Fy, Fz) and six torques (Tx, Ty, Tz) via a decoupling matrix developed during a calibration procedure. In general, a minimum of six strain gages are required, and many designs utilize many more strain gages (for example, mounting them to opposite sides, or all four sides, of each deformable beam). Also, as described in the '707 patent, one or more non-stressed strain gages may also be used to provide a baseline for temperature compensation, to reduce errors introduced by thermal drift.

The following patents and publications are assigned to the assignee of the present application and incorporated herein by reference in their entireties:
U.S. Pat. No. 10,067,019 Force/Torque Sensor Having Redundant Instrumentation and Operative to Detect Faults;
U.S. Pat. No. 11,085,838 Force/Torque Sensor Having Serpentine or Coiled Deformable Beams and Overload Beams;
U.S. Pat. No. 11,137,300 Robotic Force/Torque Sensor with Improved Temperature Compensation;
U.S. Pat. No. 11,491,663 Robotic Force/Torque Sensor with Controlled Thermal Conduction;
U.S. Pat. No. 11,747,224 Quarter-Bridge Temperature Compensation for Force/Torque Sensor;
U.S. Pat. No. 11,892,364 Torque Sensor Using Coupled Loads and Fewer Strain Gages;
2023/0049155 Gravity and Inertial Compensation of Force/Torque Sensors.

An F/T sensor is calibrated at manufacture, using a specialized calibration fixture that applies known forces and torques, and records the F/T sensor transducer outputs. A matrix is then calculated that maps the applied forces and torques to the transducer outputs. In the field, transducer outputs are resolved, using the matrix, into forces and torques experienced by the F/T sensor. However, after the F/T sensor is deployed, such as on a robot arm in a factory, a variety of different tools may be attached. Parameters of the field tool (e.g., size, shape, mass, etc.), as well as the attachment parameters (torque on the mounting bolts; whether the mounting surface is perfectly flush with the F/T sensor surface, the number and properties of intervening plates, etc.) alter the strains experienced by deformable members in the F/T sensor, and hence alter its transducer outputs. Accordingly, the manufacture calibration matrix may no longer accurately translate transducer outputs to forces and torques on the tool, and/or the F/T sensor may output spurious readings that arise, not from forces and torques applied to the tool, but from the tool physical properties and its mounting parameters. As used herein, these tool-dependent mechanical factors are referred to as “boundary conditions.” Making F/T sensors less sensitive to differences in boundary conditions would improve accuracy. Performing a full calibration of the F/T sensor in its operating environment is not feasible, as the specialized calibration fixture is not available, nor is it desirable, as it would require expertise and would impose a time-consuming procedure that interrupts the robotics operations.

The Background section of this document is provided to place embodiments of the present invention in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments described and claimed herein, mathematical and mechanical methods improve observed accuracies when F/T sensors are mounted to tools in the field. Due to differences in boundary conditions between manufacture calibration and field tooling when deployed, differences may arise in calibration matrices calculated at time of manufacture and those required for use in the field. Both mathematical methods of adapting manufacture calibration to field conditions, as well as mechanical methods for reducing the sensitivity of the F/T sensor to changes in its boundary conditions, are disclosed herein.

One embodiment relates a method of reducing or eliminating the effect of changing boundary conditions on a force and/or torque (F/T) sensor. A manufacture calibration procedure is performed. The manufacture calibration procedure yields a manufacture calibration matrix that maps transducer outputs of the F/T sensor to applied forces and/or torques under a first set of boundary conditions. Transducer outputs are obtained under a second set of boundary conditions representative of use of a deployed F/T sensor coupled to a field robotic tool. A scaling of the manufacture calibration matrix to a scaled calibration matrix that maps transducer outputs of the F/T sensor to applied forces and/or torques under the second set of boundary conditions is calculated.

Another embodiment relates to a force and/or torque (F/T) sensor having reduced sensitivity to changes in boundary conditions. The F/T sensor includes a first substructure configured to be attached to a first object and a second substructure configured to be attached to a second object. The F/T sensor further includes a plurality of measurement deformable members connecting the first and second substructures, and a plurality of transducers attached to at least some measurement deformable members. The transducers are configured to sense tensile and/or compressive strains in the measurement deformable members and transduce the forces into output signals. The F/T sensor also includes a controller configured to calculate a manufacture calibration matrix mapping transducer output signals to force and/or torque between the first and second objects under a first set of boundary conditions.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a plan view of an F/T sensor.

FIG. 2 is an enlarged view of the F/T sensor of FIG. 1 under an applied force.

FIG. 3A is a plan view showing strains in a deformable beam when affixed to a rigid plate, representing a manufacture calibration condition.

FIG. 3B is a plan view showing strains in a deformable beam when affixed to a non-rigid plate, representing a field use condition.

FIG. 4 is a flow diagram of a method of reducing or eliminating the effect of changing boundary conditions on an F/T sensor.

FIG. 5A is perspective section view of an F/T sensor having a boundary condition normalizing plate with a tool mounting plate attached to the TAP.

FIG. 5B is perspective section view of an F/T sensor having a boundary condition normalizing plate without a tool mounting plate attached to the TAP.

FIG. 6 is perspective section view of an F/T sensor having a boundary condition normalizing plate attached to the MAP.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.

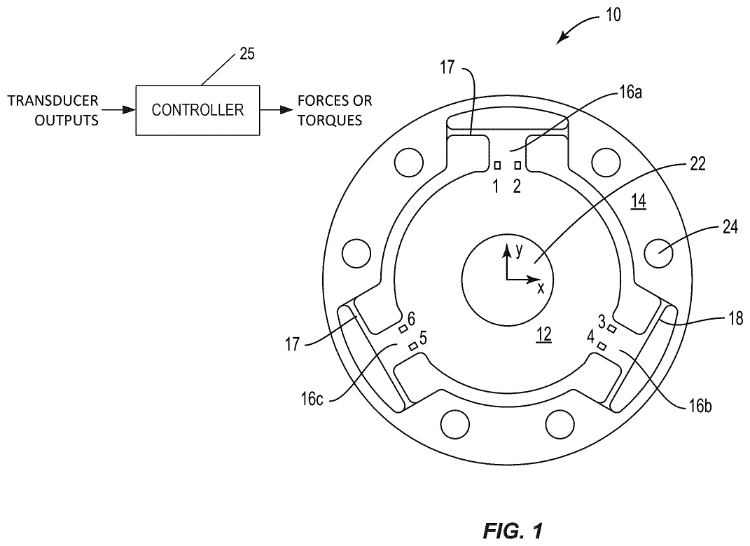

FIG. 1 depicts a plan view of one embodiment of an F/T sensor 10. A central “hub,” referred to in the art as a Tool Adapter Plate (TAP) 12 is connected to a tool. Another body arranged annularly around, and spaced apart from, the TAP, referred to in the art as a Mounting Adapter Plate (MAP) 14, is connected to a robotic arm. The TAP 12 and MAP 14 are connected to each other by a plurality of relatively thin (and hence mechanically deformable) beams 16a-c, arranged radially around the TAP 12—in the example shown, resembling spokes of a wheel. Relative force or torque between objects respectively attached to the TAP 12 and MAP 14 attempt to move the MAP 14 relative to the TAP 12, resulting in slight deformation, or bending, of at least some of the beams 16.

In the example shown in FIG. 1, each beam 16 connects directly to the TAP 12, and connects to the MAP 14 by flexures 17, which aid in the deformation of the beams 16 under mechanical loading. The TAP 12 is configured to be connected to a first object, such as a robotic tool, via a through-hole 30 or by tapped holes in the underside of the sensor 10 (not shown in FIG. 1). The MAP 14 is configured to be connected to a second object, such as a robot arm, via a plurality of mounting holes 32. Although not clear from this view, the TAP 12 and MAP 14 are only connected by the beams 16. Transducers, such as strain gages, 1-6 are affixed to the upper surface of each deformable beam 16. A controller 25 calculates forces and/or torques between the first and second objects, in response to outputs of the transducers 1-6. The controller 25 may be integral to the F/T sensor 10, or may be external, connected by wires or wirelessly.

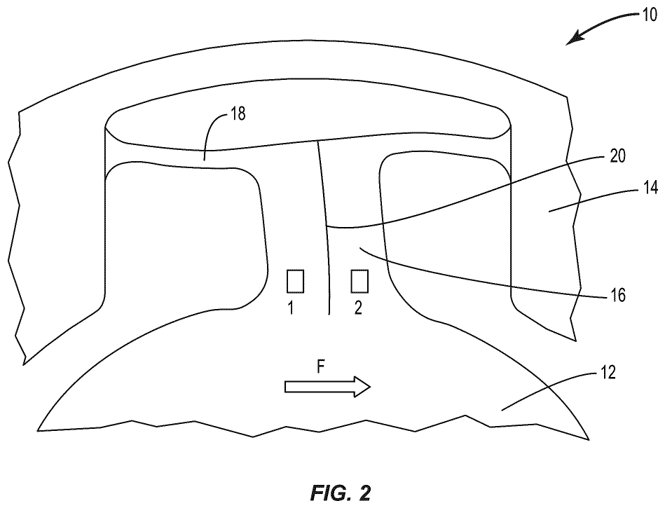

FIG. 2 is an enlarged view of one beam 16a undergoing deformation due to a force F applied to the TAP 12, relative to the MAP 14. This force deforms the beam 16a slightly to the left (the figure is not to scale). A compressive force is induced on the left side surface of beam 16a, and a tensile force is induced on the right side surface. Strain gages mounted on these surfaces generate strong signals, of opposite polarity, from which the deformation, and hence the applied force F, is ascertained. Additionally, the two sides of the upper surface of the beam 16a also experience the compressive and tensile strain, in a magnitude that increases with distance away from a neutral axis 18. The neutral axis 18 is the line, running generally down the center of the upper surface of the beam 16a, at which compressive strain experienced on the left side of the beam 16a transitions to tensile strain on the right side. Accordingly, the beam 16a undergoes no strain at the neutral axis 18.

While the “hub and spoke” configuration described above is a common design, in general F/T sensors may assume a wide range of shapes and configurations. In all such configurations, a first substructure (e.g., TAP 12) connects to a first object (e.g., robotic tool) and a second substructure (e.g., MAP 14) connects to a second object (e.g., robot). Deformable members (e.g., beams 16) connect the first and second substructures. Transducers (e.g., strain gages) sense compressive and/or tensile strains in the deformable members, and transduce these into some form of output signal, which can be processed to resolve forces and/or torques between the first and second objects. A manufacturing calibration process calculates a matrix that maps transducer outputs to the sensed forces and torques.

Changes in F/T sensor sensitivity, in dependence on changes in the specific boundary conditions applied to the sensor, is a known issue. For example, when mounting an F/T sensor 10 to a calibration fixture, the sensor 10 has one set of sensitivities to loadings, which can be expressed as a calibration matrix. For example, a calibration matrix may be a 6×6 matrix relating six signals derived from strain gages to six unique load axes (Fx, Fy, Fz, Tx, Ty, Tz) applied to the F/T sensor 10. When mounted to different tooling in the field, however, using this manufacture calibration matrix may result in inaccuracies and/or spurious readings. Whenever the tooling mounted to an F/T sensor 10 changes, the F/T sensor's proper calibration may shift to a varying degree, depending on the specific tool and F/T sensor 10 combination. As applications push for higher and higher payloads in smaller and smaller packages, this issue becomes more prevalent and pronounced.

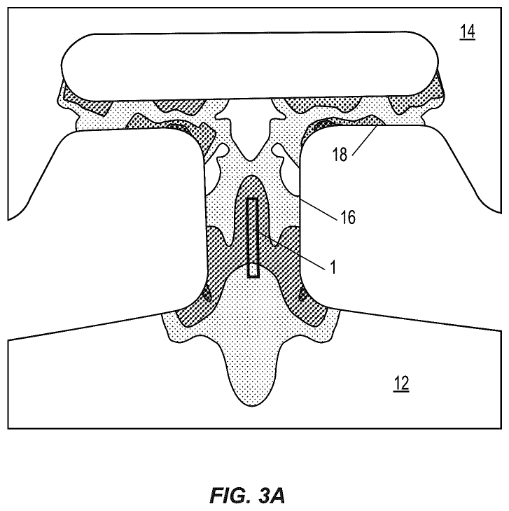

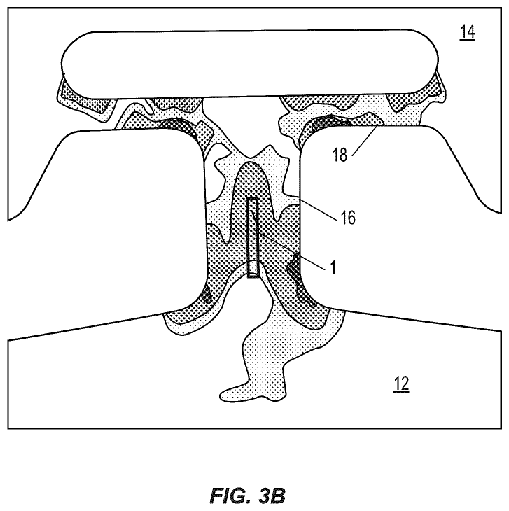

FIG. 3A shows the strains on a deformable member 12d, with an F/T sensor 10 attached to a perfectly rigid plate, and FIG. 3B shows the same for a non-rigid plate. In both figures, greater strain is indicated by darker shading, and the central box is a strain gage. The figures are very similar, except FIG. 3B has slightly more total strain in the strain gage. Additionally, FIG. 3A shows approximately equal strain on both sides of the bottom of the deformable beam. In contrast, in FIG. 3B, there is more strain on the right side of the beam than on the left side. FIG. 3A reflects the strain an F/T sensor 10 experiences during manufacture calibration, and FIG. 3B shows what it may experience when deployed in the field. Clearly, the F/T sensor 10 will output different readings in the two cases. This error is magnified for top-gaged sensors, such as the ones described in U.S. Pat. No. 10,422,707, cited above.

According to aspects of the present disclosure, a variety of methods mitigate the changes in boundary conditions from impacting sensor accuracies. For example, one known solution is to provide the field tooling to the F/T sensor manufacturer. The manufacture calibration conditions can then more closely match those experienced in the field, reducing the shift between manufacture and field calibration matrices. This solution has limited applicability, however, as an F/T sensor may be used with a wide variety of different robotic tools in the field. Also, it may be expensive or otherwise impractical for an F/T sensor manufacturer to obtain copies of all robotic tools to which its F/T sensors may be coupled.

According to one aspect, a mathematical method modifies the manufacture calibration in order to match it to customer conditions more closely. As one example, a sample of F/T sensors 10 are calibrated using both the manufacturer's calibration tooling and also tooling that approximates field tools—i.e., calibrating both sets of boundary conditions. A transformation between the two calibrations is determined. Once this transformation is determined, it is applied to calibrations using manufacturer tooling, so that in the field (at least for similar tools), the F/T sensors 10 will deliver better accuracy performance than they would without this transformation being applied.

Alternatively, in view of the expense and practicality drawbacks discussed above of the manufacturer obtaining and calibrating using field tools, CAD models of the field tools are obtained, and a calibration procedure is simulated using analytical methods such as Finite Element Analysis. A transformation between the physical manufacture calibration and the simulated field calibration is then calculated.

In other aspects, the F/T sensor 10 is deployed with the manufacture calibration matrix, and a field characterization process is performed to determine an individualized scaling to be applied to the manufacture calibration, which most accurately fits the F/T sensor combined with the field tooling.

For example, a highly accurate reference F/T sensor 10—e.g., one with more transducers, which has been extensively characterized—is deployed. The field tool is attached, and representative robotic operations are performed. The outputs of the reference F/T sensor 10 are then used to correct the manufacture calibration to actual field use. Once this correction is determined, standard F/T sensors 10 are substituted for the reference F/T sensor 10, and they use the corrected calibration matrix.

As another example, a dynamic characterization is performed, wherein a reference robotic motion profile (or minimum requirements a motion profile must meet) is provided. Using a small number of fixed weights, the robot executes the motion profile, and the F/T sensor transducer outputs are recorded. An individualized transformation between the manufacture calibration and an ideal field calibration is then determined, and used to improve the accuracy of the deployed F/T sensors 10. As advantage of this method is that the robot operator need only program and execute the reference robotic motion profile and record the transducer outputs. The F/T manufacturer, with intimate knowledge of the F/T sensor design and with extensive expertise in F/T sensor calibration, can then calculate the calibration transformation and provide it to the robot operator. As one example of a reference robotic motion profile constraint, the weight mass and center of mass of the field tool are defined to be within certain bounds. Another example constraint is that the center of mass changes with orientation, relative to the F/T sensor 10 being characterized.

In another aspect, a reference fixture, without active sensing, is configured to characterize the relation between manufacture calibration and field characterization. In one example, such a fixture is configured with constant-force springs, which apply known forces and torques at predetermined locations and in predetermined directions, mimicking the effects of a field tool. A transformation is then calculated that adapts the manufacture calibration matrix to the anticipated field environment. As another example, the F/T sensor 10 is deployed, and known masses are manipulated by the field tooling in order to determine a transformation from the manufacturer calibration to the field operating environment.

In all of these methods, the transformation between the manufacture calibration and a field characterization may be as simple as a linear scaler to a calibration matrix, or as complex as a neural network describing changes between matrices based on observed trends, or similar machine-learning techniques known in the art. Representative scalings include scaling a force and/or torque axis by a value, scaling a gage by a value, and producing a matrix which describes the (potentially nonlinear) scaling between manufacture calibration matrix and the field matrix resulting from the field characterization(s).

All of these techniques for scaling calibrations can be targeted through design to focus on certain measurement axes, for example if a field operation comprises a weighing operation while in motion, high-accuracy force data may be required and torque data may be unimportant, which may correlate more closely to the center of mass shifting during movement than the mass of the actual package. In such a case, it is desirable to determine the shift in calibrations using tooling which allows a fixed mass's center of gravity to change during characterization, to focus the transformation in on forces, and ignore moment loads. These techniques may be applied to perform a full or partial characterization of the sensor while it is deployed in a field robotic operation.

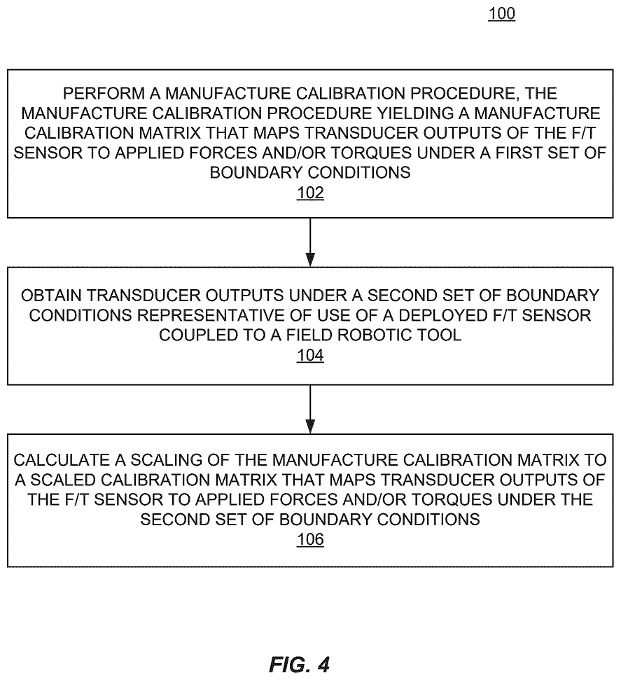

FIG. 4 shows the steps in a method 100 of reducing or eliminating the effect of changing boundary conditions on an F/T sensor. A manufacture calibration procedure is performed (block 102). The manufacture calibration procedure yields a manufacture calibration matrix that maps transducer outputs of the F/T sensor to applied forces and/or torques under a first set of boundary conditions. Transducer outputs are obtained under a second set of boundary conditions representative of use of a deployed F/T sensor coupled to a field robotic tool (block 104). Various methods of obtaining transducer outputs under the second set of boundary conditions are discussed above. A scaling of the manufacture calibration matrix to a scaled calibration matrix is calculated (block 106). The scaled calibration matrix maps transducer outputs of the F/T sensor to applied forces and/or torques under the second set of boundary conditions.

As noted, some of the change in boundary conditions results from how the F/T sensor 10 is attached to a tool in the field. Sensitivity of the F/T sensor 10 to such changes is reduced through mechanical adaptations.

In one aspect, the F/T sensor design is modified to make deformable members 16 more flexible relative to regions of the sensor 10 which are intended to rigidly distribute load. In another aspect, deformable members are designed to isolate the boundary conditions from the sensitive deformable members 16 which typically contain transducers such as strain gages 1-6. For example, stacks of material with widely varying Young's moduli or stiffness are utilized, such that displacements due to applied loads are confined generally to be rigid body motions, rather than contact events where varying contact pressure distributions can impact sensor boundary conditions.

In another aspect, all force and torque loads are constrained to flow into the F/T sensor 10 through defined small regions. As one example, a central shaft on the sensor receives all loads, and may be secured with only a single nut. This design reduces the impact of boundary conditions by forcing all loads through a small region of the F/T sensor 10 such that changes in boundary pressure distributions and stiffnesses are not apparent to the rest of the sensing structure. F/T sensor accuracy is improved through this reduction in sensitivity to boundary conditions. As another example, loads flow into the sensing structure through a small number of defined regions—for example, only three contact points transfer loads between field tooling and the F/T sensor.

In one aspect, additional material is added between the F/T sensor 10 and a robotic tool. For example, interface plates between the F/T sensor 10 and the robotic tool help reduce the impacts of changing boundary conditions. Similarly, changes in calibration performance between a field operation and manufacture calibration are reduced. In some cases, accuracy degradation between different robotic tools can be reduced by adding a plate between the F/T sensor 10 and the field tools.

In addition to mathematically mapping a manufacture calibration to a field environment, the effects of differing boundary conditions on measured forces and torques may also be minimized by structural design of the F/T sensor 10. Adhémar Jean Claude Barréde Saint-Venant, a French elasticity theorist, articulated the Saint-Venant Principle as, “the difference between the effects of two different but statically equivalent loads becomes very small at sufficiently large distances from load.” In other words, for an elongate body to which force or torque is applied, stress distribution in the body becomes more uniform the further away from the point of F/T application. Only in the region of the body very near the point of F/T application, is the stress distribution complex, and dependent on the specifics of the F/T application (e.g., point force or distributed). As a rule of thumb, for a cylindrical column, moving longitudinally away from the point of application of force by more than one diameter of the column is sufficient for the stress induced by the force to be uniform across the column.

According to aspects of the present disclosure, force and torque measurements are isolated from variations in boundary conditions by transmitting the force or torque through a rigid elongate member, that is affixed to the TAP 12 and/or MAP 14 of an F/T sensor 10. This member is referred to herein as a boundary condition normalizing plate.

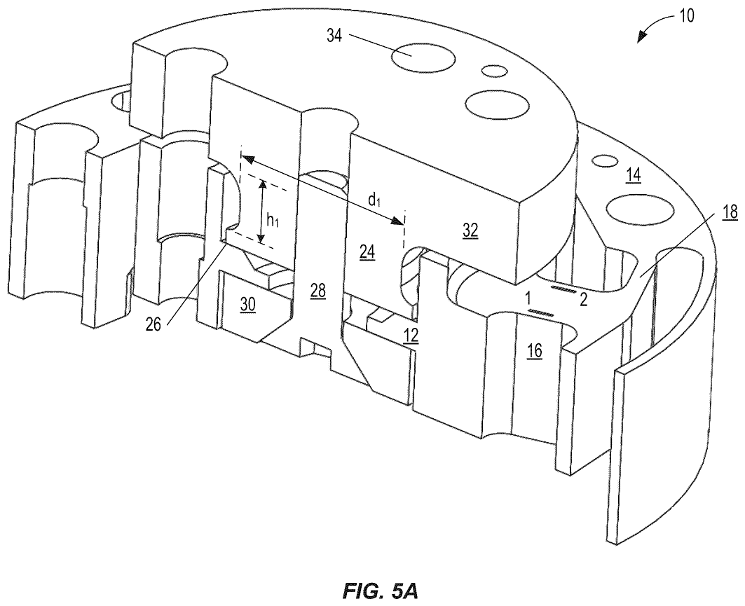

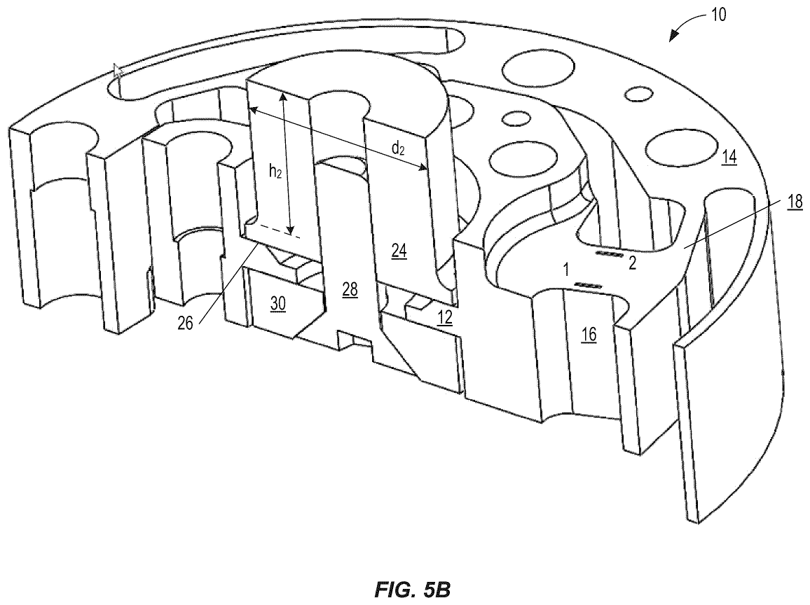

FIG. 5A shows an F/T sensor 10 with a boundary condition normalizing plate 24. The F/T sensor 10 is similar to that depicted in FIGS. 1 and 2. A central TAP 12 connects to an annular MAP 14 by deformable beams 16. The visible deformable beam 16 has two strain gages 1 and 2 affixed to an upper surface thereof, and it connects to the MAP 14 via flexure 18. In other designs, the strain gages 1, 2 could differ in number and/or orientation, such as being attached to the side surfaces of the deformable beam 16. In this particular design, the TAP 12 includes a central bore, within which the boundary condition normalizing plate 24 is disposed. A lower surface of the boundary condition normalizing plate 24 rests on a shelf 26 formed in the TAP 12, and is secured by a central fastener 28. In this example, a mounting plate 30 is sized and shaped to accept the fastener 28 and spread its clamping force over a lower surface of the TAP 12. It is advantageous that the boundary condition normalizing plate 24 is affixed to the TAP 12 at a central point or region, although it need not necessarily be secured by a single fastener 28. For example, a plurality of smaller fasteners may be tightly clustered in the central location. Alternatively, a mechanical clamp, such as a circular dovetail, may be employed. In general, those of skill in the art may devise numerous ways to rigidly affix the boundary condition normalizing plate 24 to the TAP 12, preferably concentrating the clamping force in a small central region.

As indicated in FIG. 5A, the operative portion of the boundary condition normalizing plate 24 has a height h₁ and a characteristic diameter d₁. In the embodiment depicted in FIG. 5A, a tool mounting shelf 32 is integrally formed with the boundary condition normalizing plate 24, and extends outward of the characteristic diameter d₁, partially overhanging at least the deformable beams 16. This is to provide a standard pattern of interface bores, for mounting to existing robotic tools. The tool mounting shelf 32 is “free floating”—it does not contact any portion of the F/T sensor 10, and it has no impact on force/torque measurement.

FIG. 5B shows the F/T sensor 10 with a taller different boundary condition normalizing plate 24, which does not include a tool mounting shelf 32. This configuration performs better at isolating the strain gages 1-6 from boundary conditions, but may only be appropriate for connection to a subset of robotic tools (or require additional interface structures to attach existing robotic tools). This boundary condition normalizing plate 24 has a height h₂ and a characteristic diameter d₂.

In general, it is desirable to maximize the ratio h/d of a boundary condition normalizing plate 24, given the constraints of any given F/T sensor 10 design and its operating environment. For example, the height h of a boundary condition normalizing plate 24 may be constrained by available space, or the need for a mounting shelf 32 or the like to accommodate specific robotic tools, as in the example of FIG. 5A. The characteristic diameter d of a boundary condition normalizing plate 24 should be minimized, but must be sufficient to provide the mechanical strength and withstand all foreseeable applied F/T loads, and the stiffness to transmit those loads to the TAP 12 without yield or failure. Accordingly, there is no definitive ratio h/d that will be optimum in all cases. The Saint-Venant Principle counsels that the boundary condition normalizing plate has a large height h, but this will be constrained by size and other application factors. The boundary condition normalizing plate preferably has a small characteristic diameter d to maximize the ratio h/d, but this will be constrained by the strength and rigidity required for a particular application. It is well within the skill of those of skill in the art, given the teachings of the present disclosure, to balance the competing design constraints, and maximize the achievable ratio h/d of a boundary condition normalizing plate in any particular application.

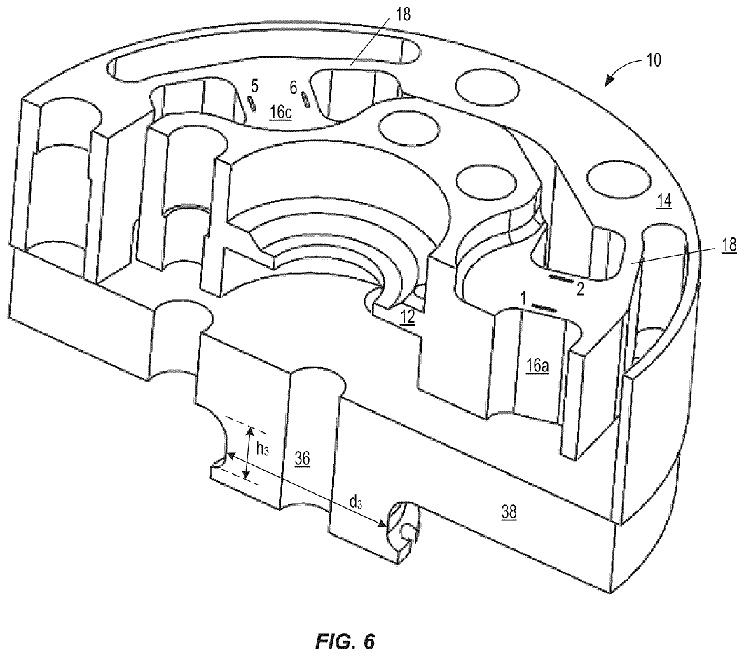

FIG. 6 shows an F/T sensor 10 with a boundary condition normalizing plate 36 attached to the MAP 14, via a MAP mounting shelf 38. A robotic arm (not shown) attaches to the lower surface of the boundary condition normalizing plate 36. Neither the boundary condition normalizing plate 36 nor the MAP mounting shelf 38 contacts the TAP 12 or any deformable beam 16. The boundary condition normalizing plate 36 has a height h₃ and a characteristic diameter d₃, and it acts as described above, isolating the MAP 14 from boundary conditions of forces and torques applied by the robotic arm. An F/T sensor 10 may include a boundary condition normalizing plate 24 attached to the TAP 12, or a boundary condition normalizing plate 36 attached to the TAP 14, or both.

Although the boundary condition normalizing plates 24, 36 are depicted and described herein as cylindrical in shape, with a central bore, this shape is not a limitation of aspects of the present disclosure. A boundary condition normalizing plate should be generally elongate, in a longitudinal direction normal to the TAP 12 or MAP 14, but it may have any cross-sectional shape, such as square, octagonal, and the like. As used herein, the term “characteristic diameter,” in the case of a boundary condition normalizing plate has a non-circular cross section, refers to the width of the boundary condition normalizing plate. In the case where a boundary condition normalizing plate has a circular cross section, the term “characteristic diameter” refers to the diameter of the circular cross section. Additionally, while the boundary condition normalizing plate 36 (FIG. 6) is shown with a central bore, this is shown as an option for the passing of wires, cables, pneumatic fluid tubes, or the like into or through the F/T sensor 10. A central bore is not a limitation on the shape of a boundary condition normalizing plate 36.

Aspects of the present disclosure present numerous advantages over the prior art, and may provide one or more of the following technical effects. By adapting the manufacture calibration matrix, either mathematically or through mechanical features of the F/T sensor, such as one or two boundary condition normalizing plates, degradation in sensor accuracy and/or spurious F/T readings resulting from changes in boundary conditions are reduced or eliminated. This improves F/T sensor performance, without requiring a full manufacture calibration procedure for every F/T sensor in every field environment (i.e., for each field tool that may be coupled to the F/T sensor). In particular, the boundary condition normalizing plate(s) present uniform forces and torques to measurement deformable members of the F/T sensor, that are independent of the boundary conditions of the F/T application.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa.

As used herein, the term “configured to” means set up, organized, adapted, or arranged to operate in a particular way; the term is synonymous with “designed to.” As used herein, the term “substantially” means nearly or essentially, but not necessarily completely; the term encompasses and accounts for mechanical or component value tolerances, measurement error, random variation, and similar sources of imprecision.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended embodiments are intended to be embraced therein.

What is claimed is:

1. A method of reducing or eliminating the effect of changing boundary conditions on a force and/or torque (F/T) sensor, comprising:
performing a manufacture calibration procedure, the manufacture calibration procedure yielding a manufacture calibration matrix that maps transducer outputs of the F/T sensor to applied forces and/or torques under a first set of boundary conditions;
obtaining transducer outputs under a second set of boundary conditions representative of use of a deployed F/T sensor coupled to a field robotic tool; and
calculating a scaling of the manufacture calibration matrix to a scaled calibration matrix that maps transducer outputs of the F/T sensor to applied forces and/or torques under the second set of boundary conditions.

2. The method of claim 1, wherein obtaining transducer outputs under a second set of boundary conditions comprises:
performing a second calibration procedure using a field robotic tool, the second calibration procedure yielding a second calibration matrix that maps transducer outputs of the F/T sensor to applied forces and/or torques under the second set of boundary conditions; and
determining the scaling of the manufacture calibration matrix that yields the second calibration matrix.

3. The method of claim 1 wherein obtaining transducer outputs under a second set of boundary conditions comprises:
simulating a field calibration procedure using a model of a field robotic tool, the simulated field calibration procedure yielding a simulated field calibration matrix that maps transducer outputs of the F/T sensor to applied forces and/or torques under the second set of boundary conditions; and
determining the scaling of the manufacture calibration matrix that yields the simulated field calibration matrix.

4. The method of claim 1, wherein obtaining transducer outputs under a second set of boundary conditions comprises:
performing a robotic operations using a reference F/T sensor and a field robotic tool;
recording the reference F/T sensor transducer outputs;
determining the scaling of the manufacture calibration matrix that maps transducer outputs of the reference F/T sensor to applied forces and/or torques under the second set of boundary conditions; and
applying the scaling to the manufacture calibration matrix for F/T sensors deployed in the field.

5. The method of claim 1, wherein obtaining transducer outputs under a second set of boundary conditions comprises:
defining at least minimum requirements for a reference motion profile;
performing the reference motion profile with the F/T sensor and a field robotic tool;
recording the F/T sensor transducer outputs during the reference motion profile;
determining the scaling of the manufacture calibration matrix that maps transducer outputs of the F/T sensor to applied forces and/or torques under the second set of boundary conditions experienced during the reference motion profile.

6. The method of claim 5, wherein the reference motion profile defines weight mass and center of mass to be within predetermined bounds.

7. The method of claim 5, wherein the reference motion profile defines that the center of mass of the field robotic tool changes with orientation relative to the F/T sensor being calibrated.

8. The method of claim 1, wherein obtaining transducer outputs under a second set of boundary conditions comprises:
defining at least minimum requirements for a reference motion profile;
performing the reference motion profile with the F/T sensor and a field robotic tool;
recording the F/T sensor transducer outputs during the reference motion profile;
determining the scaling of the manufacture calibration matrix that maps transducer outputs of the F/T sensor to applied forces and/or torques under the second set of boundary conditions experienced during the reference motion profile.

9. The method of claim 1, wherein obtaining transducer outputs under a second set of boundary conditions comprises:
mounting the F/T sensor in a reference fixture imposing the second boundary conditions;
applying forces and/or torques to the F/T sensor;
recording transducer outputs of the F/T sensor; and
determining the scaling of the manufacture calibration matrix that maps transducer outputs of the F/T sensor to applied forces and/or torques under the second set of boundary conditions.

10. The method of claim 9, wherein applying forces and/or torques to the F/T sensor comprises using constant-force springs to apply known forces and/or torques.

11. The method of claim 9, wherein applying forces and/or torques to the F/T sensor comprises:
deploying the F/T sensor in an operational environment with a field robotic tool, under the second set of boundary conditions;
manipulating known masses using the field tooling;
recording the F/T sensor transducer outputs while manipulating known masses using the field tooling; and
determining the scaling of the manufacture calibration matrix that maps transducer outputs of the F/T sensor to applied forces and/or torques under the second set of boundary conditions.

12. A force and/or torque (F/T) sensor having reduced sensitivity to changes in boundary conditions, comprising:
a first substructure configured to be attached to a first object;
a second substructure configured to be attached to a second object;
a plurality of measurement deformable members connecting the first and second substructures; and
a plurality of transducers attached to at least some measurement deformable members, the transducers configured to sense tensile and/or compressive strains in the measurement deformable members and transduce the forces into output signals; and
a controller configured to calculate a manufacture calibration matrix mapping transducer output signals to force and/or torque between the first and second objects under a first set of boundary conditions.

13. The F/T sensor of claim 12, further comprising isolating deformable members configured to isolate boundary conditions from the measurement deformable members.

14. The F/T sensor of claim 12, wherein forces and torques are configured to flow into the F/T sensor through predetermined regions.

15. The F/T sensor of claim 12 further comprising a first boundary condition normalizing plate attached to one of the first and second substructures, the first boundary condition normalizing plate having at least a portion comprising an elongate member oriented perpendicular to the attached substructure, and configured to present uniformly distributed forces and torques to the measurement deformable members.

16. The F/T sensor of claim 15 wherein the first boundary condition normalizing plate further comprises a mounting plate configured to provide a mechanical interface for connection to a substructure or attached object.

17. The F/T sensor of claim 15 wherein the first boundary condition normalizing plate has a height and characteristic diameter, and wherein the ratio of the height to the characteristic diameter is greater than one.

18. The F/T sensor of claim 15, wherein the first boundary condition normalizing plate is attached to a substructure by a single fastener or mechanical clamp, or a plurality of fasteners clustered in a central region of the boundary condition normalizing plate.

19. The F/T sensor of claim 15, wherein the first boundary condition normalizing plate is attached to a substructure by an attachment means comprising a single fastener or mechanical clamp, or a plurality of fasteners clustered in a central region of the first boundary condition normalizing plate.

20. The F/T sensor of claim 19 wherein the effective contact diameter between the first boundary condition normalizing plate and the substructure is greater than a diameter of the attachment means, so as to improve torque load capacity of the first boundary condition normalizing plate and the substructure interface.

21. The F/T sensor of claim 15, wherein the first boundary condition normalizing plate attached to the first substructure and further comprising a second boundary condition normalizing plate attached to the second substructure.
